(19) United States
(12) Patent Application Publication
(10) Pub. No.: US 2004/0070479 A1
(43) Pub. Date: Apr. 15, 2004

(54) Via-less electronic structures and methods

(76) Inventors: Yutaka Doi, Columbia, MD (US); Bruce Lee, Chippewa Falls, WI (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/269,761

(22) Filed: Oct. 10, 2002

(51) Int. Cl. H01F 5/00

(52) U.S. Cl. 336/200

(57) ABSTRACT

A solenoid having a plurality of stacked gapped circle windings, with each winding being rotated relative to any adjacent windings, and with each winding lying in a plane perpendicular to a common axis.

### FIELD OF THE INVENTION

The field of the invention is inductors.

### BACKGROUND OF THE INVENTION

A solenoid often comprises a conductor formed in the shape of a cylindrical helix such that successive coils/windings are stacked on top of each other while being separated by an insulator. Although cylindrical helixes are often a preferred shape, non-cylindrical helixes, and inductors formed from conductors stacked in step-wise fashion such as that shown in U.S. Pat. No. 5,225,969 (herein incorporated by reference in its entirety) are also known. However, in many instances the characteristics of the magnetic fields generated by known solenoids and coiled inductors are not entirely satisfactory. As such, there is an ongoing need to develop new types of solenoids and coiled inductors. Moreover, it is generally desirable to improve methods of forming components such as solenoids to minimize the costs and wastes associated with formation.

### SUMMARY OF THE INVENTION

The present invention is directed to a solenoid comprising a stack of circular conductors wherein each circular conductor is substantially planar, and all the planes defined by the circular conductors are substantially perpendicular to a common axis. Moreover, each circular conductor is an arc forming a circle that is complete except for a single gap separating the ends of the arc such that the ends are separated only by a minimum possible thickness, and each arc of the solenoid is coupled to at least one other arc by a short vertical conductive connection.

It is contemplated that the inductors described herein are best formed through the use of incremental and/or direct write methods as described in U.S. Pat. Nos. 6,251,488 and 6,268,684, each of which is herein incorporated by reference in its entirety.

It is contemplated forming a solenoid as a stack of near complete circles rather than as a cylindrical helix will provide for a magnetic field having desirable characteristics when current flows through the solenoid.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1A is a side view of a gapped circle solenoid embodying the invention.

FIG. 1B is a top view of the solenoid of FIG. 1A.

FIG. 1C is a bottom view of the solenoid of FIG. 1A.

FIG. 2 is a perspective view of the conductor portion of the solenoid of FIG. 1A.

FIG. 3A illustrates a first gapped circle winding of the solenoid of FIG. 1A.

FIG. 3B illustrates a second gapped circle winding of the solenoid of FIG. 1A.

FIG. 3C illustrates a third gapped circle winding of the solenoid of FIG. 1A.

FIG. 4 is a cross sectional view of the gapped circle solenoid of FIG. 1A.

FIG. 5 illustrates a pair of gapped circle windings coupled by a vertical interconnect.

### DETAILED DESCRIPTION

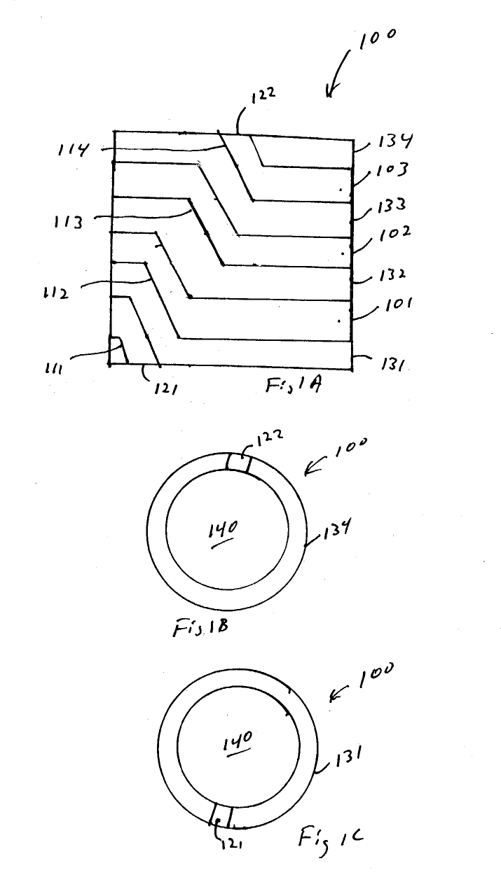

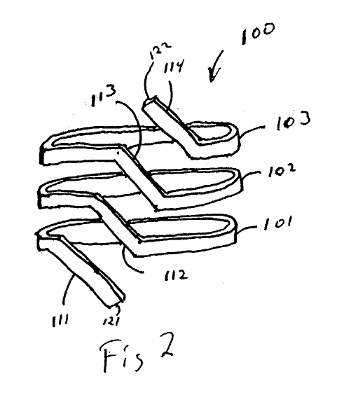

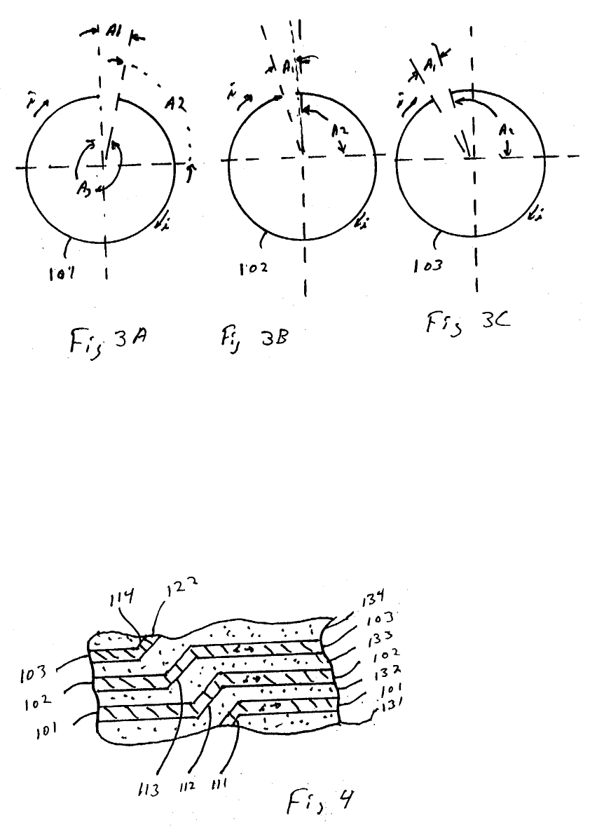

Referring to FIGS. 1A-4 a preferred solenoid 100 comprises a plurality of gapped circle windings 101-103 coupled by a plurality of vertical interconnects 111-114, with windings 101-103 being separated by insulator layers 131-134, and solenoid 100 also comprising ends/tabs 121 and 122, and core 140. Windings 101-103 are preferred to be substantially similar in shape and size, but to be rotated relative to each other such that the end of one winding is adjacent to the opposite an end of a neighboring winding. As shown in FIGS. 1A-1C, solenoid 100 is cylindrical, and each of the windings is substantially planar and lies in a plane perpendicular to the center axis of solenoid 100.

Windings 101-103 may be formed from any material through which electrical current can flow, and may be formed as a series of small adjacent deposits or as one or more ribbons. While direct write methods are preferred and may be required in order to obtain desirable characteristics, other methods are contemplated as well. Such methods may include traditional component formation methods or methods not yet known.

Windings 101-103 are preferred to form circles that are complete except for a single gap having a width D1 as shown in FIG. 5. It is preferred that the width D1 of the gap in any particular winding be as narrow as possible, preferably as narrow as the method of formation permits. Thus, if the solenoid is being formed by deposition, and the deposition system being used deposits materials in 1 mil cubes, the width of the gap is preferred to be 1 mil. In some instances the width D1 will be less than or equal to the vertical separation D2 between adjacent windings. If a deposition system is used to form each winding, and the deposition system has a minimum deposition size, it is preferred that the gap have a width equal to the minimum deposition size. Alternative embodiments may utilize wider gaps, and it is contemplated that gaps as large as 20% of the radius or as large as 12 degrees may be used. In some instances minimum gap size may be chosen to prevent shorting between windings and across gaps.

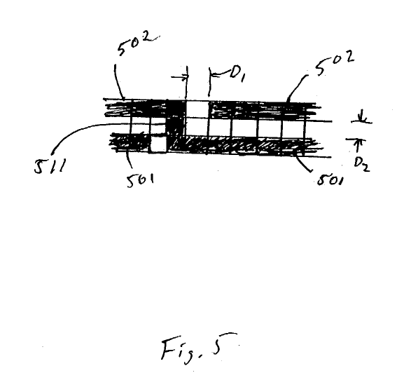

In comparing a first winding to an adjacent second winding, the windings are preferred to be similar in all respects other than their orientation. The windings will differ in regard to orientation as it is preferred that adjacent winding be rotated relative to each other to permit the end of one winding to be coupled to the end of an adjacent winding. FIGS. 3A-3C illustrate the relative rotation of three adjacent windings where the gapped circles shown are equivalent to the inner perimeters of adjacent windings. Angle A1 is a measure of the size of the arc cut out of the circle by the gap, A2 is the angle indicating the orientation of a given winding, and A3 is the angular measurement of the arc formed by the winding.

In some embodiments, the inner perimeter of each winding will be rotated relative to any adjacent winding by a distance greater than the width of the gap of the adjacent winding as shown in FIG. 5. If a winding and its gap are each viewed as an arc with the gap having an angular measurement of A1 degrees, each success winding will need to be rotated by more than A1 degrees. However, it is contemplated that each successive winding should not be rotated more than two times A1 degrees. By way of example, a winding having a gap of 12 degrees is preferably rotated between 12 and 24 degrees relative to any adjacent windings.

The amount of rotation between windings will affect the orientation of interconnects used to electrically couple adjacent windings together. FIGS. 1A and FIG. 5 provide examples of two different interconnect embodiments. In FIG. 1, the ends of adjacent windings to be coupled are not aligned vertically. As such, the vertical interconnects 111-114 are not perpendicular to the windings. In FIG. 5, however, the ends of adjacent windings to be coupled are aligned vertically, and interconnect 511 is perpendicular to windings 501 and 502.

Solenoid 100 may be formed by: (a) depositing a conductive trace as a gapped/partial circle; (b) depositing an insulator over a majority of the conductive trace; (c) depositing a conductive trace in a partial circle over the deposited insulator layer and an exposed end portion of the preceding conductive trace layer; and (d) repeating steps b and c until the solenoid is complete.

Alternatively, solenoid 100 may be formed by depositing conductive material to form a plurality of planar arcs wherein each arc measures 360-A1 degrees, and adjacent arcs are rotated relative to each other by at least A1 degrees. Such a method may also involve forming the arcs in a manner that they all have a common radius and have linearly aligned center points.

The use of this embedded solenoid replaces the use of a surface mount solenoid device. This enables wider latitude on board design and frees up space on the surface of the PCB for other electronic devices.

Thus, specific embodiments and methods of forming gapped circle solenoids have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A solenoid comprising a plurality of stacked gapped circle windings, with each winding being rotated relative to any adjacent windings.

2. The solenoid of claim 1 wherein each winding of the plurality of stacked gapped circle lies in a plane perpendicular to a common axis.

3. The solenoid of claim 2 wherein each winding comprises a gap having a width that is less than 20% of the radius of the winding.

4. The solenoid of claim 1 wherein a deposition system is used to form each winding, the deposition system having a minimum deposition size, with each winding comprising a gap having a width equal to the minimum deposition size.

5. The solenoid of claim 1 wherein each winding comprises a gap having a width less than or equal to the smallest distance separating any adjacent windings.

6. The solenoid of claim 1 wherein the inner perimeter of each winding is rotated relative to any adjacent winding by a distance greater than the width of the gap of the adjacent winding.

7. The solenoid of claim 6 wherein the inner perimeter of each winding is rotated relative to any adjacent winding by a distance less than or equal to twice the width of the gap of the adjacent winding.

9. A method of forming a solenoid comprising forming a plurality of stacked gapped circle windings, with each winding being rotated relative to any adjacent windings.

10. The method of claim 9 wherein the solenoid is formed by incremental deposition.

11. The method of claim 10 further comprising:
providing a substrate:
depositing a conductive trace on the substrate as a gapped circle with the gap being an arc measuring less than 90 degrees;
depositing an insulator over most, but less than all, of the exposed conductive trace so as to leave an end portion of the conductive trace exposed; and
depositing a conductive trace in a partial circle over the deposited insulator and the exposed end portion.

12. The method of 11 wherein a deposition system having a minimum deposition size is used to form the solenoid, and the width of the gap in each of the plurality of gapped circle windings is equal to the minimum deposition size.
